(19) United States
(12) Patent Application Publication
(10) Pub. No.: US 2011/0131944 A1
(43) Pub. Date: Jun. 9, 2011

(54) FALSE-TWIST BELT

(75) Inventors: Shunichi Nishiwaki, Nara (JP); Yoshihiro Konishi, Nara (JP); Akihiko Kuriya, Nara (JP); Takashi Yamamoto, Nara (JP)

(73) Assignee: NITTA Corporation, Osaka-shi, Osaka (JP)

(21) Appl. No.: 13/057,478

(22) PCT Filed: Aug. 8, 2008
(86) PCT No.: PCT/JP2008/064615

§ 371 Date: Feb. 4, 2011

(51) Int. Cl. D02G 1/04; F16G 1/04

(52) U.S. Cl. 57/336; 474/266

(57) ABSTRACT

Two false-twist belts are each entrained about crowned pulleys. The belts are arranged so that their outer-facing surfaces cross one another with one belt pressed against the other. Yarn is passed between these false-twist belts and twisted. The bending rigidity in the lateral direction of the false-twist belts is set to a value in which the outer-facing surfaces of the false-twist belts are rounded into a convex curvature at the position where the belts are pressed against each other.

### TECHNICAL FIELD

The present invention relates to a false-twist belt used in a yarn false-twist texturing process.

### BACKGROUND ART

In the case of a false-twist belt, a plurality of tensile cords is embedded in the longitudinal direction of a belt body comprised of rubber material and the like, and woven fabric is applied to the belt's inner-facing surface that makes contact with a pulley. The belt's inner-facing surface is covered with the woven fabric to prevent exposure of the tensile cords embedded in the inner-facing side of the belt and also to reinforce the strength of the belt in the lateral direction.

The rubber shrinks during its curing, and as for the belt having the above-discussed structures, shrinkage of the inner-facing side where the woven fabric is attached and shrinkage of the outer-facing side comprised of only rubber material are uneven. Therefore, when the belt is cured, the belt curls towards the outer-facing side, and in turn, a lateral sectional profile of the belt's outer-facing surface shows deformation in a concave shape.

In yarn twist texturing using a false-twist belt, a pair of false-twist belts is arranged with their belt-drive directions crossed at a right angle and with their outer surfaces facing each other. Yarn is fed in the direction inclined 45 degrees relative to both of the running directions of the belts and between the outer-facing surfaces of the two belts. The yarn is nipped between the outer-facing surfaces of the running false-twist belts and is subjected to torsional force as it is twisted while passing between the false-twist belts. However, if a belt's outer-facing surface is bent in a concave curve in the lateral direction, the yarn is only nipped by the edges of the false-twist belts, and thus a stable twist cannot be applied to the yarn.

As for these problems, there is known an art by which the bending rigidity in the lateral direction of the false-twist belt is strengthened in order to restrain the warp caused after curing. An example of such art is the Japanese unexamined patent publication No. 2002-013033, which discloses structures that separate the belt body into a rubber surface layer on the outer-facing side and a reinforcing layer on the inner-facing side where tensile cords are embedded, as well as embedding woven fabric between the rubber surface layer and the reinforcing layer, in addition to woven fabric applied to the belt's inner-facing side.

### DISCLOSURE OF INVENTION

An object of the present invention is to improve the running performance of false-twist belts in order to enhance a belt's life and the quality of a yarn product.

An inventive false-twist belt comprises an outer-facing surface that engages with a yarn during yarn twist texturing and an inner-facing surface that engages with a crowned pulley, and a flexural modulus of 15 MPa or less in the lateral direction of the belt.

According to another aspect of the invention, the inventive false-twist belt comprises the outer face that engages with a yarn during yarn twist texturing and the inner-facing surface that engages with a crowned pulley, and knitted fabric is applied to the inner-facing surface.

Furthermore, according to another aspect of the invention, an inventive false-twist apparatus performs false-twist texturing of a yarn by feeding the yarn between a pair of false-twist belts entrained about crowned pulleys. The outer-facing surfaces of the false-twist belts are rounded in a convex curvature in the belt lateral direction at a position where the false-twist belts are pressed together and in contact with each other.

### BRIEF DESCRIPTION OF DRAWINGS

FIG. 1 is a cross-sectional view of a false-twist belt of the present embodiment.

FIG. 2 is a schematic view of a false-twist apparatus that employs the false-twist belts of the present embodiment.

FIG. 3 schematically illustrates the arrangement of a bending test.

FIG. 4 illustrates deflection measured in the bending test.

FIG. 5 is a diagram illustrating the time variation of the moving average of a belt misalignment shift in inventive examples and a comparative example.

FIG. 6 is a scatter plot illustrating the relationship between a flexural modulus and the misalignment shift in the inventive examples and the comparative example.

FIG. 7 is a scatter plot illustrating the relationship between fabric thickness and the misalignment shift in the inventive examples and the comparative example.

### BEST MODE FOR CARRYING OUT THE INVENTION

In the following, an embodiment of the present invention will be explained with reference to the drawings.

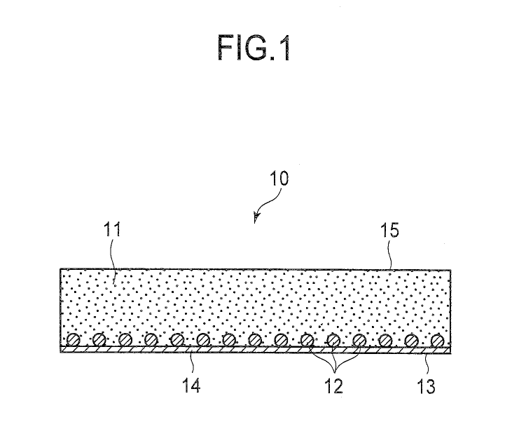

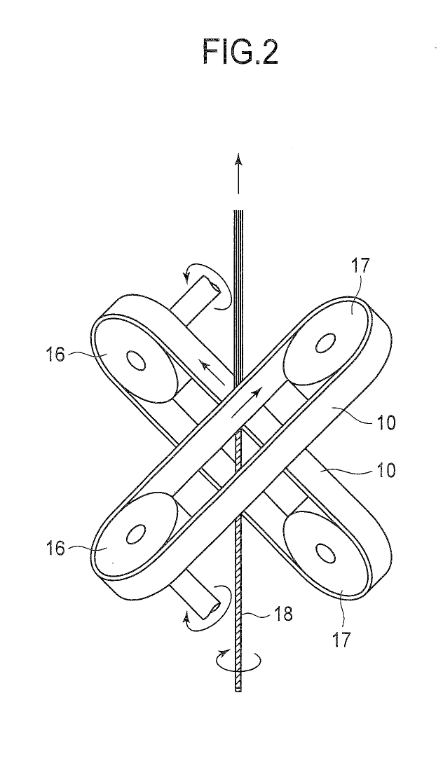

Referring to FIG. 1 and FIG. 2, the structures of a false-twist belt of the present embodiment and its arrangement in an application will be explained.

FIG. 1 is a cross-sectional view of a false-twist belt 10 of the present embodiment. FIG. 2 schematically illustrates the configuration when false-twist texturing using the belt 10 is applied to a yarn. The belt 10, for example, is an endless belt mainly comprised of synthetic resins. In the present embodiment, as shown in FIG. 1, the belt 10 includes a belt body 11 of rubber material, tensile cords 12 embedded inside the belt body 11, and knitted fabric 14 applied on the belt's inner-facing surface 13. The tensile cords 12 are arranged side by side in the longitudinal direction of the belt at a predetermined interval, inside the belt body 11 at a position adjacent to the belt's inner-facing surface 13, and the inner-facing surface 13 is covered with the knitted fabric 14. In contrast, the rubber material remains exposed on the belt's outer-facing surface 15.

Since wear resistance and oil resistance are required for the belt body 10, a material including NBR, H-NBR, EPDM, or a combination thereof is preferably employed as the rubber material for the belt body 10. Furthermore, rubber hardness within JIS (Japanese Industrial Standards) A70-A80 may be employed, but JIS A75 is preferable.

As for the tensile cords 12, polyester fiber, aramid fiber, glass fiber, or the like, of denier 1000 or less, is selected. The tensile cords 12 function as tension members in the longitudinal direction of the belt, and are arranged at a ratio of 20 cords/inch or more across the lateral direction of the belt.

As for the knitted fabric 12, a fabric with a thickness of 0.36 mm or less (preferably from 0.34 mm to 0.31 mm or less) following the adhesive treatment and with a predetermined stretchability is selected. Furthermore, the flexural modulus (bending modulus) of the belt in the lateral direction of the belt after curing is set at 15 MPa or less. Furthermore, the minimum flexural modulus may be approximately 5 MPa or larger, in regard to the wear resistance. However, these values are only examples and not limitations. Incidentally, the knitted fabric 14 may include polyester fiber.

Note that electrical conductivity is required for the false-twist belt, since static electricity generally builds up on the belt as the result of the friction between the belts. As for electrically conductive belts, there is known a belt in which electrical conductivity may be a characteristic of the rubber itself, or it may be a characteristic of rubber adhesives that are used to adhere the rubber and the fabric together. In the present embodiment, electrically conductive fibers are intertwined into the knitted fabric so that it has electrical conductivity.

As illustrated in FIG. 2, a pair of false-twist belts 10 is used in the false-twist apparatus. Each of the false-twist belts 10 is entrained about a drive pulley 16 and a driven pulley 17. The belt-bearing surfaces of the drive pulleys 16 and the driven pulleys 17 are crowned in a barrel shape. The two false-twist belts are arranged such that their outer-facing surfaces 15 face each other at around the center of the belt span and cross at a predetermined angle. Yarn 18 passes upward in FIG. 2 between the two false-twist belts that face each other. The yarn 18 is pinched by the outer-facing surfaces 15 of the false-twist belts 10 and twisted by the two running belts 10, and thus, false twisted. Namely, the yarn 18 is twisted on the upstream side and untwisted on the downstream side from the false-twist belts 10. In the present embodiment, the two false-twist belts 10 cross at 90 degrees, and each of the belts 10 is driven in a direction inclined about 45 degrees with respect to the direction in which the yarn 18 travels.

In the false-twist apparatus, a force oriented towards the centers of the belt-bearing surfaces of the pulleys 16 and 17 acts on each of the false-twist belts 10, due to the crowned shape of the belt-bearing surfaces of the pulleys 16 and 17. However, since the two crossed false-twist belts 10 are driven in contact each other, each of the false-twist belts 10 is put under a thrust force in the lateral direction (i.e., the belt width direction), which is exerted by the other belt.

Conventionally, the false-twist belt employs a double-layer structure to enhance the bending rigidity in the lateral direction of the belt, which in turn enhances the flatness of the belt, and thereby prevents bending toward the outer-facing side after curing to achieve a stable yarn nip. However, when the belt's outer-facing surface is very flat, the resistance due to the contact between the two facing false-twist belts increases and the lateral thrust force acting on the belts also increases. As a result, each belt's misalignment shift on the belt-bearing surface of the pulleys is increased and causes each belt's running performance to deteriorate. Thereby, untwisting tension control is hampered since the contact area between the false-twist belts and the yarn becomes unstable. Furthermore, the increase in the frictional resistance generates heat in the belt, which causes deterioration in the belt properties and reduces the belt's operational life. A change in the physical properties of the rubber results in greater variability in the quality of the yarn product. Furthermore, belts with high rigidity may reduce the quality of the yarn since contact between the yarn and the edge of the belt may result in over-twisting of the yarn.

The inventors of the present application rigorously investigated the behavior of the false-twist belts of the false-twist apparatus and discovered that the misalignment shift of the false-twist belts can be reduced by reducing the bending rigidity of the belt in its lateral direction (contrary to the conventional method), and thereby, the running performance of the belts is improved and the above-mentioned issues are resolved.

### EXAMPLES

In the following, detailed effects of the embodiment of the present invention will be explained with reference to inventive examples and a comparative example.

The inventive examples 1-3 and the comparative example 1 all use false-twist belts with the cross-sectional structure of FIG. 1. However, inventive examples 1-3 use false-twist belts in which knitted fabric of 0.37 mm, 0.31 mm, and 0.25 mm thickness, respectively, following the adhesive treatment, was applied to the belt's inner-facing surface, while comparative example 1 uses a false-twist belt to which woven fabric of 0.65 mm thickness, instead of the knitted fabric, was applied after the adhesive treatment. The bending test and the running test were carried out on each of the inventive examples 1-3 as well as the comparative example 1.

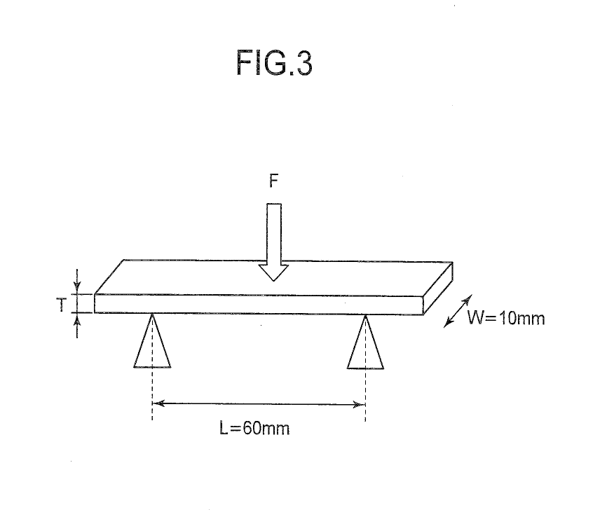

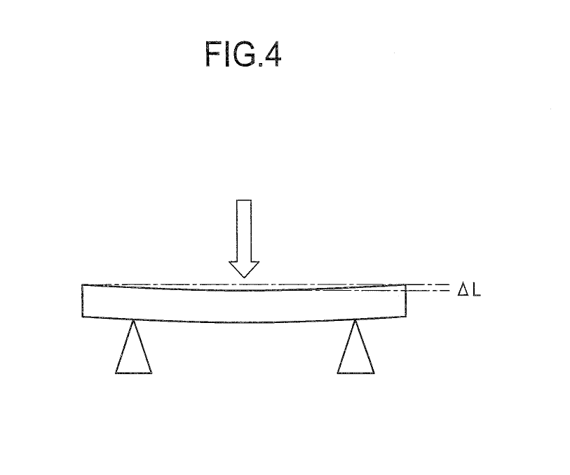

In the bending test, the flexural modulus was measured in the lateral direction for each of the false-twist belts. The measurement was performed in accordance with Japanese Industrial Standard JIS K7171, the testing method for plastic bending characteristics. Namely, a slab of each false-twist belt was cut out as a sample having width W=10 mm in the longitudinal direction of the belt and a length in the lateral direction long enough to provide a span length L=60 mm. As schematically illustrated in FIG. 3, the samples were horizontally placed on two simple supports spaced 60 mm apart, and the center of the sample span was depressed at a ratio of 2 mm/min in the vertical direction. The deflection at the center of the span was measured as a displacement ΔL from the horizontal level of the upper-facing surface of the sample, as illustrated in FIG. 4.

In the bending test, loads F were measured at five points under conditions of the strain within the range of 0.05-0.25% for calculating flexural modulus E=σ/ε from strain ε (%) and stress σ (N/mm²) for each of the points, and in turn the flexural modulus of each sample was calculated as the mean value of the five flexural modulus calculations. Incidentally, the strain ε and the stress σ were calculated by the following equations.

$$ɛ = \frac{6 T \cdot Δ L}{{L}^{2}} σ = \frac{3 L \cdot F}{2 W \cdot {T}^{2}}$$

Here, T denotes the thickness of the sample piece (belt).

From the bending test, the flexural modulus in the lateral direction of the false-twist belt of the comparative example 1, to which the woven fabric was applied, was 24.22 MPa. The flexural moduli in the lateral direction of the false-twist belts of the inventive examples 1-3, to which the knitted fabric was applied, were 15.34 MPa, 14.93 MPa, and 14.48 MPa, respectively.

On the other hand, in the running test, belt positions were measured to evaluate the running stability of the false-twist belts. First, each pair of false-twist belts installed about the pulleys was arranged with the belts facing each other and crossing at about 90 degrees, as shown in FIG. 2. The belts were driven prior to the measurement under the condition that the belts did not make contact with each other, so as to align the false-twist belts at the center of the crowned belt-bearing surfaces of the pulleys. After that, both belts were driven pressed against each other. The position of a belt was measured by a laser displacement meter disposed on one side of the belt, where a laser beam was emitted onto the side-facing surface of the belt to measure the position of the belt's side-facing surface.

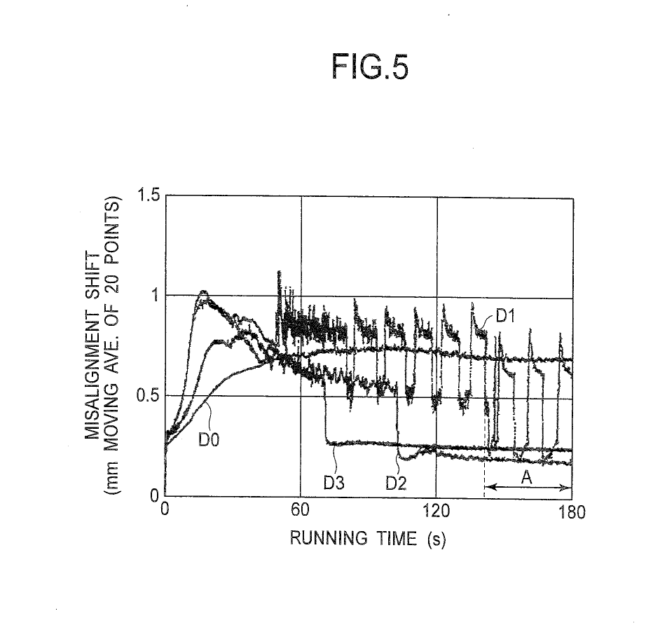

FIG. 5 is a diagram showing the relationship between the running time of the running test and the misalignment shift value of the false-twist belt. In FIG. 5, the abscissa indicates the belt running time (seconds) and the ordinate indicates the mean of the misalignment shift values (mm) measured at 20 points. Namely, each of the data series on the diagram represents a moving average of 20 data points. Data series D0 represents the result of the running test of the comparative example 1, data series D1 represents the result of the running test of the inventive example 1, data series D2 represents the inventive example 2, and data series D3 represents the inventive example 3. Note that in this test, the mean of the misalignment shift values in the interval A (160s-180s) was used to evaluate the misalignment shift, since the running conditions for comparative example 1 and inventive examples 1-3 were considered to already be substantially stable in the interval A.

In the results of the running tests, the evaluation value (the mean) of the misalignment shift for the false-twist belt of the comparative example 1, using the woven fabric, was 0.704 mm, and the evaluation values (the means) of the misalignment shifts for the false-twist belts of the inventive examples 1-3, using the knitted fabric, were 0.530 mm, 0.197 mm, and 0.254 mm, respectively.

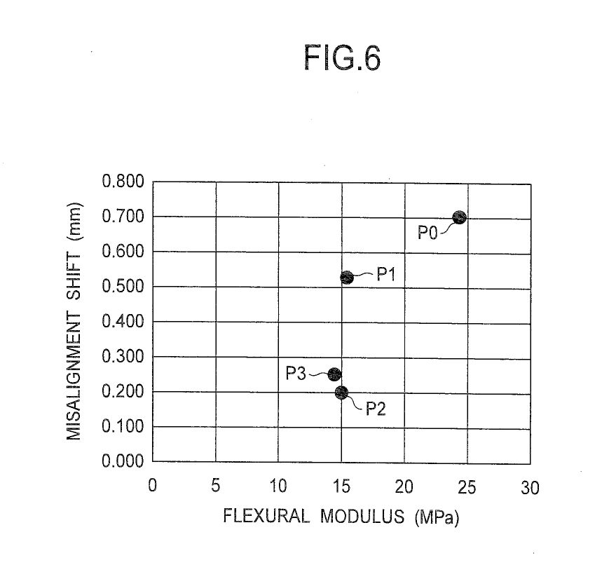

FIG. 6 is a scatter plot representing the relationship between the evaluation values (in mm) of the misalignment shift and the flexural modulus (MPa) in the lateral direction of the belt for each of the comparative example 1 and the inventive examples 1-3. In FIG. 6, point P0 represents the comparative example 1 and points P1-P3 represent the inventive examples 1-3, respectively. It is notable that the misalignment shift is significantly reduced when the flexural modulus in the lateral direction of the belt is below 15 MPa.

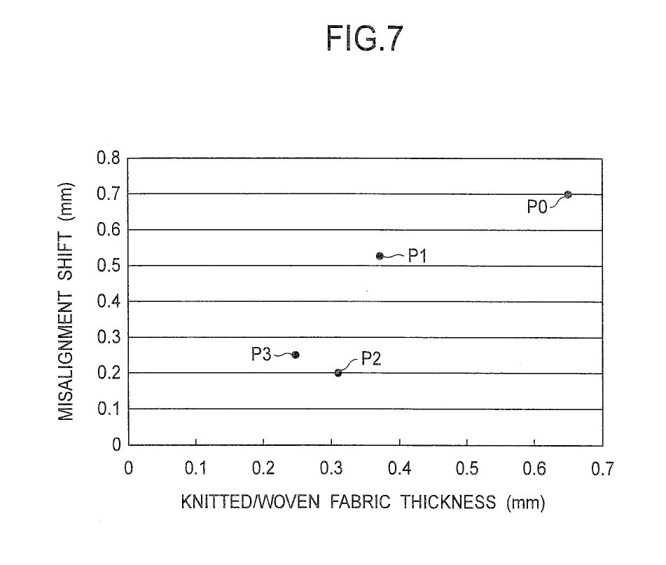

Furthermore, FIG. 7 is a scatter plot illustrating the relationship between the fabric thickness and the misalignment shift (evaluation values) in the comparative example 1 and in the inventive examples 1-3. As shown in FIG. 7, the misalignment shift is significantly reduced when the fabric thickness is about 0.36 mm or less (or from 0.34 mm to 0.31 mm or less). As well as in FIG. 6, point P0 represents the comparative example 1 and points P1-P3 represent the inventive examples 1-3, respectively.

The characteristics of the comparative example 1 and the inventive examples 1-3, and the results of the tests are listed below in table 1.

TABLE 1

| | Fabric | Thickness | Flex. Modulus | Shift |
|---|---|---|---|---|
| | type | (mm) | (MPa) | (mm) |
| Comp Ex. 1 | Woven | 0.65 | 24.22 | 0.704 |
| Inv Ex. 1 | Knitted | 0.37 | 15.34 | 0.530 |
| Inv Ex. 2 | Knitted | 0.31 | 14.93 | 0.197 |
| Inv Ex. 3 | Knitted | 0.25 | 14.48 | 0.254 |

As described above, according to the present embodiment, the misalignment shift of the false-twist belts is significantly reduced, and thus, the running performance of the belts is improved.

As described in the diagram of FIG. 5, during the first stage of the running test, the inventive examples 1-3 with the knitted fabric show large misalignment shift compared to the comparative example 1 with the woven fabric. This may be related to the fact that the friction coefficient of the false-twist belt surface of the inventive examples is high in the first stage of the running test and to the fact that the belt surface around the center of the span is slightly rounded in a convex curvature in the lateral direction due to the influence of the crowned feature of the pulleys and due to the weak rigidity of the belt in its lateral direction. On the other hand, the belt surface near the center of the span of the false-twist belt of the comparative example is substantially flat due to its high rigidity. Namely, the friction between the false-twist belts of the inventive examples is substantially higher than that of the comparative example, because the contact between the false-twist belts of the inventive examples when they cross one another is surface-to-surface contact between the convex surfaces, while the contact between the false-twist belts of the comparative example is point-to-point contact between the edges. Thereby, the belts of the inventive examples are displaced or misaligned further than in the comparative example. However, as the running time progresses, the contact area of the belt is worn and the friction coefficient diminishes, and in turn, the friction between the false-twist belts of the inventive examples diminishes. As a result, the belt is moved to the center of the belt-bearing surface by the self-tracking effect of the crowned pulley. Even when the belt is moved toward the center of the pulley, the contact area between the inventive belts does not vary substantially in response to the movement of the belt, since the belt surfaces are rounded in a convex curvature. Consequently, the belt can be moved to the center of the belt-bearing surface without substantially increasing the friction, and thus, the misalignment shift is decreased gradually.

On the other hand, as for the false-twist belt of the comparative example, the misalignment shift does not diminish even as running time progresses, as shown in the diagram of FIG. 5. This may be due to the fact that the false-twist belt surface is substantially flattened around the position where the two belts make contact with each other. Namely, when the false-twist belt is moved toward the outside of the belt-bearing surface, the outer-facing surface is further inclined since the slant of the crowned surface increases with increasing distance from the center of the crown. On the contrary, when the false-twist belt moves toward the center of the belt-bearing surface, the inclination of the outer-facing surface of the belt decreases. Therefore, when the misalignment shift is decreased by the self-tracking effect of the crowned pulley, the outer-facing surfaces of the two facing false-twist belts are moved toward the center of the belt-bearing surface of the pulley, and thus the outer-facing surfaces are brought parallel to each other at the contact position, thus increasing the contact area. As a result, the friction between the false-twist belts re-increases and each of the belts is displaced toward the outside of the belt-bearing surface of the pulley, and the misalignment shift is thus maintained. Furthermore, as for the false-twist belts of the comparative example, the self-tracking effect of the crowned pulley is small since their bending rigidity is high. This is also regarded as a factor preventing the reduction of the alignment shift in the comparative example.

Incidentally, one reason why the fluctuation of the misalignment shift is relatively small in the comparative example compared to the inventive examples may be due to the fact that stick slip may occur less in the comparative example, since the false-twist belts in the comparative example make contact with one another only at their edges.

As described above, according to the present embodiment, the misalignment shift of the belt during the operation is reduced and the running performance is enhanced as well as the quality of the yarn improved by stabilization of the contact between the false-twist belts and the yarn. The present embodiment also prevents the generation of heat and extends the operational life of the belt by mitigating rubber deterioration. Furthermore, the negative effects that changes in the physical properties of the rubber have on the quality of the yarn are also reduced.

Note that the detailed structure of the false-twist belt is not restricted to the present embodiment. Other structures are also possible if they provide the rigidity in which the outer-facing surface of the false-twist belt is rounded in a convex curvature in the lateral direction of the belt at the position where the two false-twist belts meet.

1. A false-twist belt comprising:
an outer-facing surface that engages yarn in yarn twist texturing; and
an inner-facing surface that engages a crowned pulley; and
a flexural modulus of 15 MPa or less in the lateral direction of the belt.

2. A false-twist belt according to claim 1, wherein knitted fabric is applied to said inner-facing surface.

3. A false-twist belt according to claim 2, wherein the thickness of said knitted fabric is 0.36 mm or less after adhesive treatment.

4. A false-twist belt comprising:
an outer-facing surface that engages yarn in yarn twist texturing; and
an inner-facing surface that engages a crowned pulley; and
a knitted fabric that is applied to said inner-facing surface.

5. A false-twist belt according to claim 4, wherein a flexural modulus in the lateral direction of the belt is 15 MPa or less.

6. A false-twist belt according to claim 4, wherein the thickness of said knitted fabric is 0.36 mm or less after adhesive treatment.

7. A false-twist apparatus that performs false-twist texturing to yarn by feeding the yarn between a pair of false-twist belts entrained about crowned pulleys, and outer-facing surfaces of said false-twist belts being rounded in a convex curvature in the lateral direction of the belts at a position where said false-twist belts are pressed against each other.
